(19) United States
(12) Patent Application Publication
(10) Pub. No.: US 2026/0075446 A1
(43) Pub. Date: Mar. 12, 2026

(54) SYSTEMS AND METHODS FOR UTILIZING MACHINE LEARNING TO SUPPORT ACCESS TRAFFIC STEERING, SWITCHING, AND SPLITTING

(71) Applicant: Verizon Patent and Licensing Inc., Basking Ridge, NJ (US)

(72) Inventors: Chien-Yuan HUANG, Basking Ridge, NJ (US); Suzann HUA, Beverly Hills, CA (US); Glenda T. BALOTO, San Ramon, CA (US)

(73) Assignee: Verizon Patent and Licensing Inc., Basking Ridge, NJ (US)

(21) Appl. No.: 18/830,832

(22) Filed: Sep. 11, 2024

(51) Int. Cl. H04W 24/08; H04L 41/16; H04W 24/02

(52) U.S. Cl. CPC H04W 24/08; H04L 41/16; H04W 24/02

(57) ABSTRACT

A device may receive secure connection data and load data associated with a secure connection established between a user equipment (UE) and a core network via an untrusted access network. The device may process the secure connection data and the load data, with a machine learning model, to generate analytics associated with the secure connection, and may provide the analytics to one or more analytics consumers to cause the one or more analytics consumers to perform one or more actions based on the analytics. The one or more actions may include providing access traffic steering, switching, and splitting for the secure connection, providing mobility management for the UE, generating a policy for the secure connection, selecting a user plane function of the core network to communicate with the secure connection, or modifying the secure connection.

### BACKGROUND

Access traffic steering, switching, and splitting (ATSSS) enables traffic steering across multiple access networks at a finer granularity than a protocol data unit (PDU) session.

### BRIEF DESCRIPTION OF THE DRAWINGS

FIGS. 1A-1F are diagrams of an example associated with utilizing machine learning to support ATSSS.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing machine learning to support ATSSS.

### DETAILED DESCRIPTION OF EXAMPLE EMBODIMENTS

The following detailed description of example implementations refers to the accompanying drawings. The same reference numbers in different drawings may identify the same or similar elements.

Current techniques for multipath communication within a fifth-generation (5G) core network fail to efficiently integrate traffic management across heterogeneous access network types, such as 3rd Generation Partnership Project (3GPP) access networks, trusted non-3GPP access networks, and untrusted non-3GPP access networks, at the fine granularity level that ATSSS requires. Further complicating the matter is the involvement of different network functions (NFs) within the 5G architecture that do not effectively communicate or share data analytics for optimized policy decision-making. While a network data analytics function (NWDAF) is designed to provide predictive load condition analytics, an evolved packet data gateway (ePDG) and a non-seamless wireless local area network (WLAN) offload function (NSWOF), crucial for managing traffic through untrusted non-3GPP access networks (e.g., Wi-Fi networks), are not provided the predictive load condition analytics generated by the NWDAF.

Thus, current techniques for multipath communication within a 5G core network consume computing resources (e.g., processing resources, memory resources, communication resources, and/or the like), networking resources, and/or other resources associated with failing to effectively steer, switch, and split traffic over multiple access types in a 5G core network, failing to incorporate the ePDG and the NSWOF within an analytical scope of the NWDAF, failing to provide procedures and interfaces between the ePDG, the NWDAF, and other network functions to support data-driven and real-time policy decision-making for ATSSS, generating network congestion or bottlenecks that result from less informed traffic steering decisions, and/or the like.

Some implementations described herein utilize machine learning to support ATSSS. For example, a device (e.g., an NWDAF) may receive secure connection data and load data associated with a secure connection established between a UE and a core network via an untrusted access network. The device may process the secure connection data and the load data, with a machine learning model, to generate analytics associated with the secure connection, and may provide the analytics to one or more analytics consumers to cause the one or more analytics consumers to perform one or more actions based on the analytics. The one or more actions may include providing ATSSS for the secure connection, providing mobility management for the UE, generating a policy for the secure connection, selecting a user plane function of the core network to communicate with the secure connection, or modifying the secure connection.

In this way, machine learning may be utilized to support ATSSS. For example, an NWDAF may enhance the efficiency of operations of the core network by utilizing a machine learning model to analyze traffic flow data associated with untrusted non-3GPP access networks and to generate analytics. The analytics may provide for dynamic adjustments to traffic routing, policy formulation, and enhancements to stability of secure connections. Through the processing of comprehensive data sets, including subscriber and network function information, the NWDAF may provide analytics that guide ATSSS-related policy decisions, ensuring better alignment with fluctuating network conditions and traffic loads. Thus, the NWDAF may conserve computing resources, networking resources, and/or other resources that would have otherwise been consumed by failing to effectively steer, switch, and split traffic over multiple access types in a 5G core network, failing to incorporate the ePDG and the NSWOF within an analytical scope of the NWDAF, failing to provide procedures and interfaces between the ePDG, the NWDAF, and other network functions to support data-driven and real-time policy decision-making for ATSSS, generating network congestion or bottlenecks that result from less informed traffic steering decisions, and/or the like.

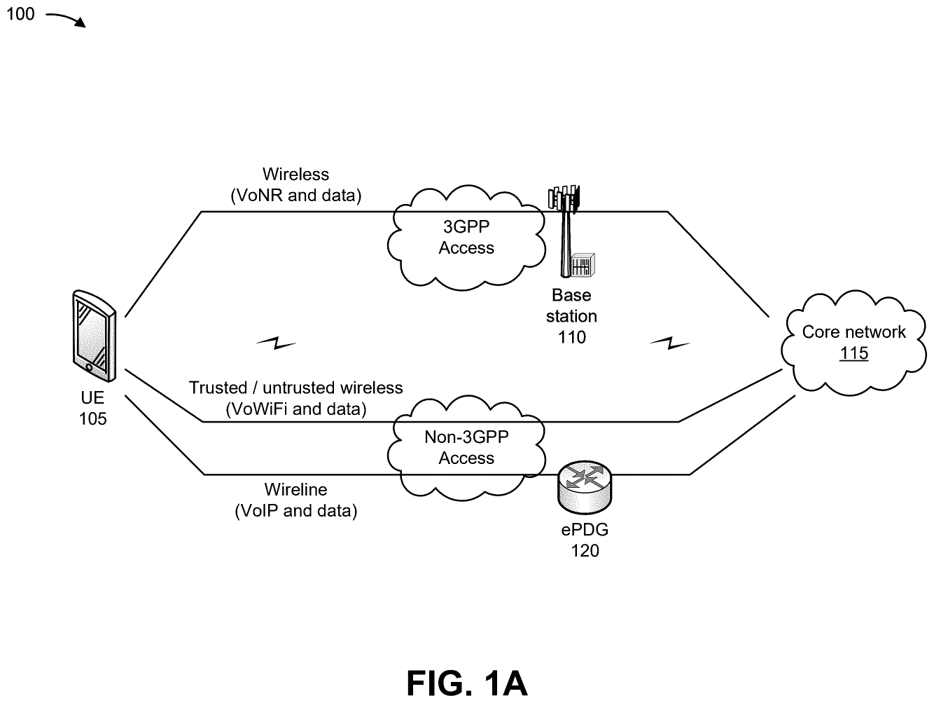

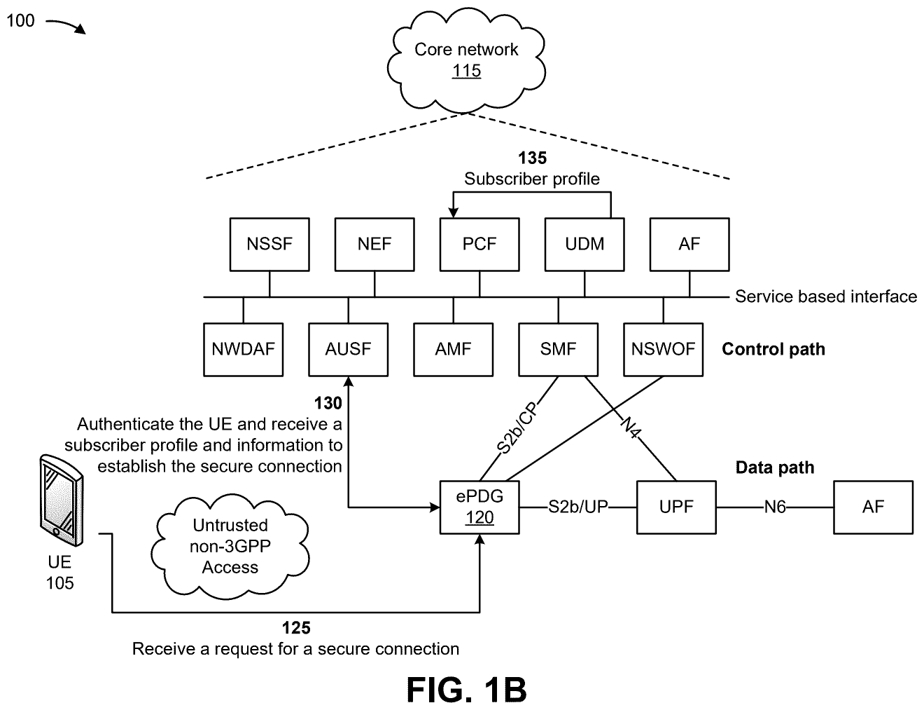

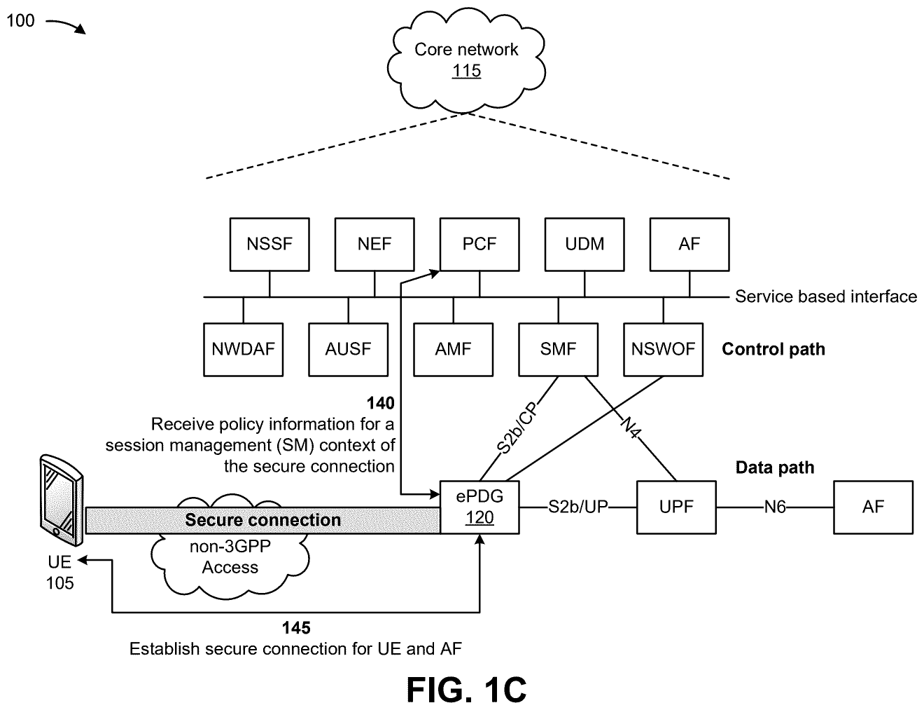

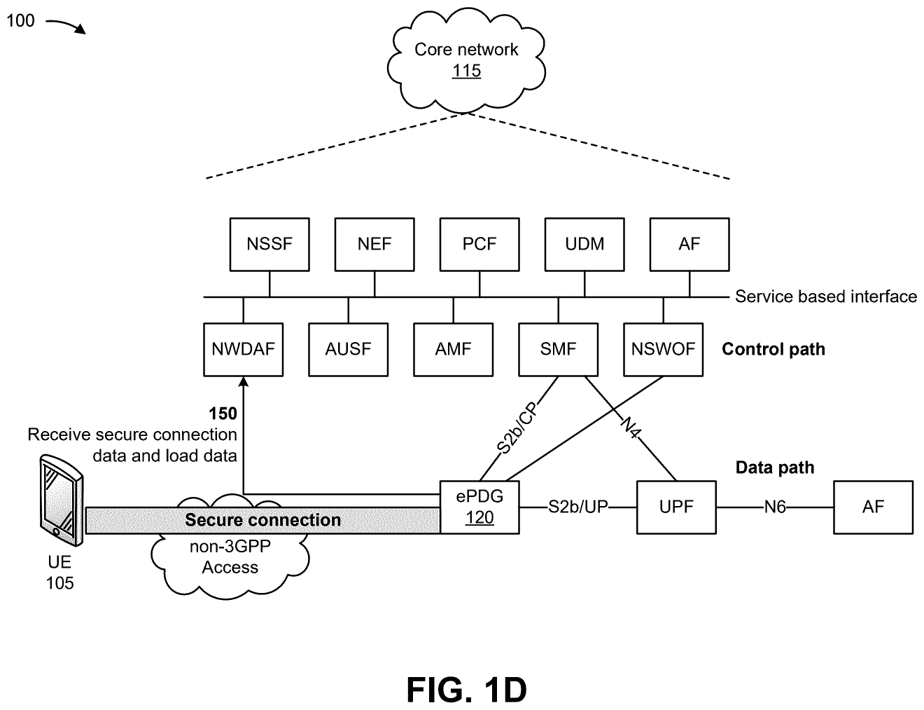

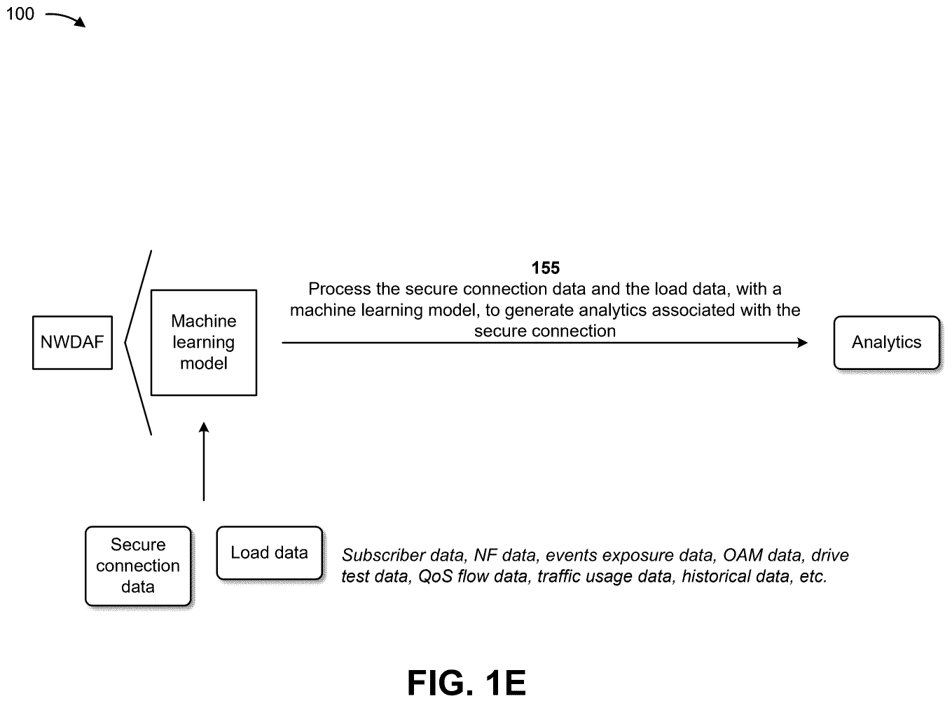

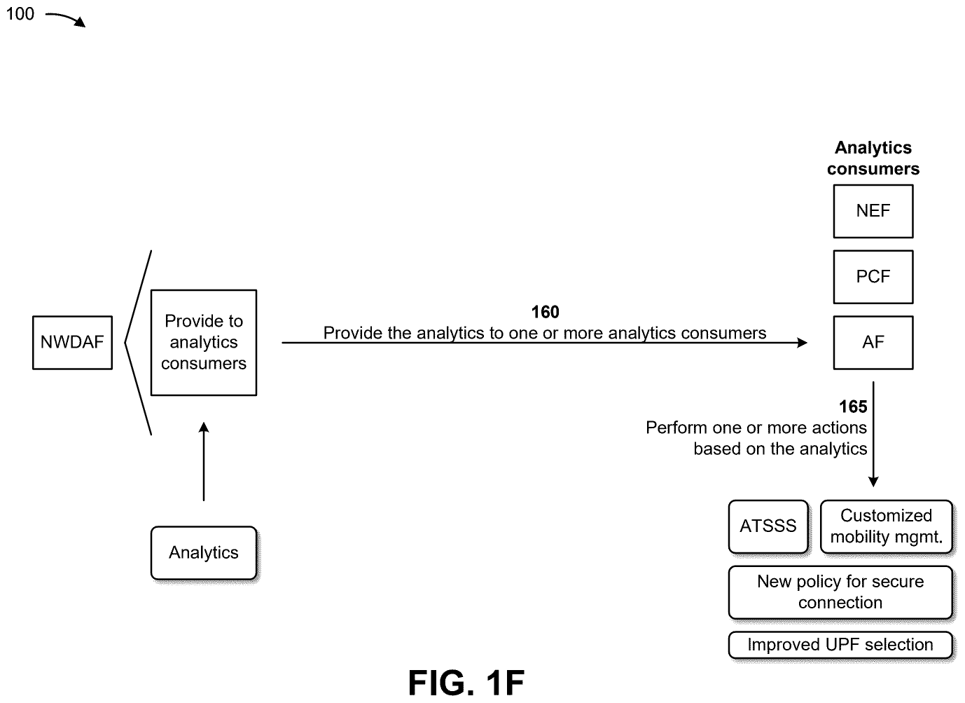

FIGS. 1A-1F are diagrams of an example 100 associated with utilizing machine learning to support ATSSS. As shown in FIGS. 1A-1F, example 100 includes a UE 105 associated with a 3GPP access network, a base station 110, a core network 115, a non-3GPP access network, and an evolved packet data gateway (ePDG) 120. Further details of the UE 105, the 3GPP access network, the base station 110, the core network 115, the non-3GPP access network, and the ePDG 120 are provided elsewhere herein.

As shown in FIG. 1A, ATSSS provides a multiaccess PDU session for which data traffic can be served over one or more concurrent access networks (e.g., a 3GPP access network, a trusted non-3GPP access network, and an untrusted non-3GPP access network). Thus, the UE 105 may connect to the core network 115 via various access networks. For example, the UE 105 may wirelessly connect to the core network 115, via the 3GPP access network (e.g., provided by the base station 110), for voice-over-New-Radio (VoNR) and data traffic. The UE 105 may wirelessly connect to the core network 115, via a trusted or an untrusted non-3GPP access network and the ePDG 120, for voice-over-Wi-Fi (VoWiFi) and data traffic. Finally, the UE 105 may connect to the core network 115, via a wireline non-3GPP access network and the ePDG 120, for voice-over-Internet-protocol (VoIP) and data traffic.

As shown in FIG. 1B, the core network 115 may include a variety of functions, such as a network slice selection function (NSSF), a network exposure function (NEF), a policy control function (PCF), a unified data management (UDM) component, an application function (AF), a network data analytics function (NWDAF), an authentication server function (AUSF), an access and mobility management function (AMF), a session management function (SMF), a non-seamless wireless local area network (WLAN) offload function (NSWOF), and a user plane function (UPF). The NSSF, the NEF, the PCF, the UDM, the AF, the NWDAF, the AUSF, the AMF, the SMF, and the NSWOF may communicate via a service-based interface (SBI) and may provide a control path for the UE 105. The ePDG 120 may communicate with the UPF via an S2b/UP interface and the UPF may communicate with the AF via an N6 interface. The ePDG 120, the UPF, and the AF may provide a data path for the UE 105. The ePDG 120 may communicate with the SMF (e.g., via an S2b/CP interface) and the NSWOF. The SMF and the UPF may communicate via an N4 interface.

As further shown in FIG. 1B, and by reference number 125, the ePDG 120 may receive a request for a secure connection from the UE 105. For example, a user of the UE 105 may generate the request for the secure connection, and may provide the request for the secure connection to the ePDG 120, via the untrusted non-3GPP access network. The ePDG 120 may receive the request when the UE 105 initiates an attempt to establish a connection via the untrusted non-3GPP access network. The request may be essential for further communication processes that rely on a secure connection for stability and reliability. In some implementations, the ePDG 120 may receive a request for an authentication token from the UE 105. The authentication token may be used for initial authentication purposes and may include one or more identifiers of the UE 105. Additionally, or alternatively, the ePDG 120 may receive a request for initial network access from the UE 105. This request may include initial configuration data, allowing the UE 105 to securely connect to the core network 115.

Additionally, or alternatively, the UE 105 may send a pre-authentication request to the ePDG 120 via the untrusted non-3GPP access network. The pre-authentication request may be useful in scenarios where preliminary security checks are mandated before full core network access is granted. Additionally, or alternatively, the request may include initial connection parameters for establishing secure communications. For example, the initial connection parameters may specify encryption methods or preferred security protocols. Additionally, or alternatively, the UE 105 may request a dynamic Internet protocol (IP) address assignment for a secure connection from the ePDG 120. This may enable the UE 105 to receive an IP address specifically configured for secure communications and data exchange.

As further shown in FIG. 1B, and by reference number 130, the ePDG 120 connects to the AUSF and the UDM through the NSWOF to authenticate the UE 105 and to receive a subscriber profile and information for establishing the secure connection. For example, based on the request for the secure connection, the ePDG 120 may connect to the AUSF and the UDM through the NSWOF. During this connection process, the ePDG 120 may utilize the NSWOF to facilitate communication with the AUSF for authentication of the UE 105. This may ensure that only authorized devices can establish secure connections, thereby maintaining network integrity. Concurrently, the ePDG 120 may retrieve the subscriber profile from the UDM, which contains necessary data pertaining to subscription services and access entitlements for the UE 105.

In some implementations, the ePDG 120 may connect to the AUSF and the UDM through the NSWOF to validate subscription status of the UE 105 and obtain necessary certificates. The certificates may serve as additional security credentials to reinforce trustworthiness. Additionally, or alternatively, the ePDG 120 may connect to additional network entities, such as the AMF, through the NSWOF for enhanced authentication processes. This multi-entity interaction allows for more robust and comprehensive authentication methods.

Additionally, or alternatively, contextual data for the UE 105 may be exchanged between the ePDG 120 and the UDM via the NSWOF during the authentication and profile retrieval process. The contextual data may include location information or historical access logs of the UE 105 for more tailored authentication criteria. Additionally, or alternatively, the security policies and encryption keys required for establishing the secure connection may be negotiated through the NSWOF. The negotiation process may ensure that both the ePDG 120 and the UE 105 are aligned on security standards. Additionally, or alternatively, the ePDG 120 may perform load balancing checks with the NSWOF prior to establishing the secure connection. The load balancing checks may ensure that network resources are efficiently allocated without overloading any single network component.

As further shown in FIG. 1B, and by reference number 135, the UDM may provide the subscriber profile to the PCF. For example, once the subscriber profile has been authenticated and verified, the UDM may transmit the subscriber profile to the PCF. This may aid in policy decision-making related to session management and access control. The PCF may utilize the subscriber profile to create and enforce policies for the secure connection, ensuring efficient network resource utilization tailored to the specific needs and privileges of the subscriber. In some implementations, the UDM may transmit the subscriber profile and quality of service (QoS) parameters to the PCF. The QoS parameters may be utilized for maintaining desired performance levels for subscriber services. Additionally, or alternatively, the subscriber profile, along with traffic and device type data, may be sent to the PCF for optimized network policy enforcement. This enriched subscriber profile data may enable the PCF to make more nuanced policy decisions that align with subscriber usage patterns.

Additionally, or alternatively, the UDM may update the PCF with subscriber status updates, including an active state or an inactive state and service tier information. Such status updates may provide for accurate billing and service provisioning. Additionally, or alternatively, for delegated network functions, the UDM may forward extended subscriber profiles incorporating additional service entitlements to the PCF. These extended subscriber profiles provide a comprehensive view of subscriber entitlements, facilitating better resource management. Additionally, or alternatively, the UDM may also send connectivity history and network usage patterns of the subscriber to the PCF to refine policy decisions. This historical data helps in predicting future usage and adapting network policies dynamically.

As shown in FIG. 1C, and by reference number 140, the ePDG 120 may receive policy information for a session management (SM) context of the secure connection. For example, the ePDG 120 may communicate with the PCF over a service-based interface (SBI) to obtain the policy information for the SM context of the secure connection. The policy information from the PCF may provide directives on how the session should be managed within the secure connection context, ensuring that traffic is optimally routed according to network policies and service level agreements (SLAs).

In some implementations, the ePDG 120 may receive service profile information from the UDM through the AUSF for the SM context of the secure connection. The service profile information may ensure that subscriber-specific policies are applied within the secure connection. Additionally, or alternatively, the policy information may include QoS parameters for optimizing traffic management during the secure connection. The QoS parameters may aid in configuring QoS settings that align with the SLAs. Additionally, or alternatively, the ePDG 120 may receive authentication data from the AUSF to validate the UE 105 before proceeding with the secure connection setup. Additionally, or alternatively, the policy information may include traffic steering policies that dictate how different types of traffic should be prioritized and routed over the secure connection. Additionally, or alternatively, the ePDG 120 may receive load information from the NWDAF to assess current network conditions and optimize the session management accordingly.

As further shown in FIG. 1C, and by reference number 145, the ePDG 120 may establish the secure connection for the UE 105 and the AF. For instance, after receiving the policy information, the ePDG 120 may proceed to configure and set up the secure connection, such as via an IP security (IPSec) tunnel that encapsulates user traffic. The secure connection may enable secure communication for voice and data services, and may ensure integrity and confidentiality in the untrusted non-3GPP access network.

In some implementations, establishing the secure connection may include the ePDG 120 configuring secure channels for different data flows between the UE 105 and the AF, thereby segmenting traffic types to adhere to specific policies and security levels. Additionally, or alternatively, establishing the secure connection may include the ePDG 120 setting up an IPSec tunnel with QoS parameters, and ensuring that traffic complies with specified QoS parameters to maintain service quality. Additionally, or alternatively, establishing the secure connection may include activating the secure connection by negotiating IPSec parameters with the ePDG 120 and ensuring that traffic is protected in the untrusted non-3GPP access network. Additionally, or alternatively, the ePDG 120 may continuously monitor and adjust the secure connection parameters based on analytics received from the NWDAF, ensuring optimal performance and security throughout the session. Additionally, or alternatively, establishing the secure connection may include the ePDG 120 establishing a seamless secure connection encompassing voice, video, and data services, facilitating uninterrupted service even when the UE 105 moves across different access networks.

As shown in FIG. 1D, and by reference number 150, the NWDAF may receive secure connection data and load data. For example, during utilization of the secure connection, the secure connection data and the load data may be generated and received by the ePDG 120. The ePDG 120 may connect with the NWDAF in order to provide the secure connection data and the load data to the NWDAF. The NWDAF may receive the secure connection data and the load data from the ePDG 120. The NWDAF may utilize the secure connection data and the load data to analyze and manage traffic over the secure connection. The secure connection data may include data identifying details of the secure connection established between the UE 105 and the ePDG 120. The load data may include data identifying metrics, such as traffic volume, data rates, and connection stability indicators, which may assist the NWDAF in evaluating and optimizing network performance.

In some implementations, the NWDAF may periodically receive the secure connection data and the load data to provide a continuous stream of information for a machine learning model of the NWDAF. For example, the secure connection data and the load data may include real-time statistics, such as packet loss rates, latency measurements, and throughputs, which may be utilized to make informed decisions about traffic steering, switching, and splitting. Additionally, or alternatively, the secure connection data and the load data may be supplemented with historical data to identify trends, predict future network conditions, and facilitate dynamic and adaptive policy management.

In some implementations, the NWDAF may receive the secure connection data and the load data from other network functions, such as the UPF or the AF. For example, the UPF may provide insights into user plane traffic, which may provide an understanding of traffic patterns and load distribution. Additionally, or alternatively, the NWDAF may receive, from the untrusted non-3GPP access network and the core network 115, additional data that may provide a comprehensive view of network performance. In some implementations, the secure connection data may include subscriber data linked to the UE 105, QoS flow data, and other events exposure data related to the secure connection. For example, subscriber data may include anonymized user activity patterns that can be used to enhance personalized services. Additionally, or alternatively, the load data may include metrics, such as jitter, signal-to-noise ratio (SNR), and error rates. The SNR may provide an understanding of a quality of a wireless signal received from the UE 105.

In some implementations, the secure connection data and the load data may be aggregated from a series of network monitoring tools and logged events over a specific duration instead of being periodically received. For example, logs from network devices (e.g., firewalls, routers, and switches) may be combined to create a comprehensive dataset. Additionally, or alternatively, the secure connection data and the load data may be derived from distributed network sensors and local edge computing devices.

As shown in FIG. 1E, the secure connection data and the load data may include subscriber data, network function (NF) data, events exposure data, operations and management (OAM) data, drive test data, QoS flow data, traffic usage data, historical data, and/or the like. The subscriber data may include data specific to the UE 105, such as subscription details, usage patterns, and activity logs. The NF data may include metrics associated with different network functions within the core network 115, including the performance and utilization of the network functions. The events exposure data may include logs and notifications related to events affecting the secure connection, such as handovers or access technology changes. The OAM data may include configuration details, management records, and performance data associated with managing the core network 115. The drive test data may include field measurements gathered during network testing, such as signal strength and quality readings. The QoS flow data may include data identifying QoS for different data flows, including latency, jitter, and packet loss metrics. The traffic usage data may include details about the volume and types of traffic handled by the core network 115. The historical data may include past performance records, anomalies, and trends.

In some implementations, the secure connection data and the load data may include subscriber-specific details. Such data may include a subscription profile, usage behaviors, and transactional logs of the UE 105, and may provide insights into user-specific patterns and requirements. Additionally, or alternatively, the secure connection data and the load data may include core network function utilization rates. Network function data may include performance metrics from various core network elements, such as utilization rates and operational statistics. Additionally, or alternatively, the secure connection data and the load data may include event logs that include details of incidents influencing the secure connection, such as handovers and changes in access technologies. Additionally, or alternatively, the secure connection data and the load data may include management and configuration data identifying configuration, administration, and performance metrics of the core network 115. Additionally, or alternatively, the secure connection data and the load data may include archived performance data. Historical logs may include trends, archiving data points, and previous performance anomalies, offering contextual background for predictive modeling and network optimization.

As further shown in FIG. 1E, and by reference number 155, the NWDAF may process the secure connection data and the load data, with a machine learning model, to generate analytics associated with the secure connection. For example, the NWDAF may utilize the secure connection data and the load data within the machine learning model to identify patterns, detect anomalies, and predict future network conditions. The machine learning model may be trained on historical data to improve predictive capabilities. The analytics generated by the NWDAF may include insights and recommendations for optimizing traffic management, enhancing QoS, and ensuring the stability of secure connections. These insights may be utilized by other network functions to make informed decisions and adjustments, thus improving the overall efficiency and performance of the core network 115.

In some implementations, the machine learning model may include a linear regression model (e.g., that predicts network latency based on the load data), a logistic regression model (e.g., that predicts whether a connection will fail or succeed), a decision tree or random forest model (e.g., for classification and regression tasks), a support vector machine model (e.g., for classification and regression tasks), a clustering model (e.g., that identifies usage patterns or anomalies), a reinforcement learning model, a convolutional neural network (CNN) model (e.g., for pattern recognition in network traffic), a recurrent neural network (RNN) model, and/or the like. In some implementations, the NWDAF may combine two or more models to generate a hybrid model that provides the analytics associated with the secure connection.

In some implementations, the NWDAF may apply the machine learning model to analyze the secure connection data and load data and extract analytics that identify usage patterns, detect deviations, and forecast network conditions. Additionally, or alternatively, the NWDAF may utilize historical datasets to enhance accuracy of the machine learning model in predicting future network scenarios, allowing for more effective resource management and planning. Additionally, or alternatively, the analytics may provide actionable insights and suggestions on traffic steering, switching policies, QoS enhancements, and overall secure connection stability, enabling other network functions to implement these recommendations in real-time or near-real-time.

As shown in FIG. 1F, and by reference number 160, the NWDAF may provide the analytics to one or more analytics consumers. For example, the NWDAF may provide the generated analytics to analytics consumers, such as the NEF, the PCF, the AF, and/or the like of the core network. The analytics consumers may utilize the analytics to improve operational efficacy and perform more informed decision-making processes. In some implementations, the NWDAF may provide the analytics to various network functions (e.g., the NEF, the PCF, and the AF) to enhance decision-making and improve network management. These network functions may utilize the analytics to optimize respective operations and ensure efficient and effective network performance. Additionally, or alternatively, the NWDAF may provide the analytics to an OAM system associated with the core network 115 to enable a holistic overview of performance metrics. The analytics may provide central management systems (e.g., the OAM system) with a comprehensive view of performance metrics, and may enable the central management systems to fine-tune network parameters accordingly.

Additionally, or alternatively, the NWDAF may provide the analytics to an application utilized by the UE 105, allowing end-users to monitor and understand a connection quality of the UE 105. This may provide users with real-time insights regarding a network experience. Additionally, or alternatively, the NWDAF may provide the analytics to a diagnostic tool within the core network 115 to automatically detect and resolve issues. The diagnostic tool may utilize the analytics for proactive maintenance and swift issue resolution. Additionally, or alternatively, the NWDAF may store the analytics in a data lake for long-term trend analysis and strategic planning. Storing analytics data in the data lake may enable extensive historical analysis and may aid in strategic decision-making for future network expansions and upgrades. Additionally, or alternatively, the NWDAF may provide the analytics to a predictive maintenance system. The predictive maintenance system may utilize the analytics to identify and mitigate potential network failures before they occur. The predictive maintenance system may interpret the analytics to identify early warning signs of failures, ensuring high network reliability and uptime.

As further shown in FIG. 1F, and by reference number 165, the one or more analytics consumers may perform one or more actions based on the analytics. For example, based on the received analytics, the analytics consumers may execute one or more actions to optimize the network performance. In some implementations, the one or more actions may include providing ATSSS for better traffic management. ATSSS may optimize traffic flow by dynamically directing traffic across multiple access networks for enhanced performance and reliability. Additionally, or alternatively, the one or more actions may include a real-time adjustment to QoS settings, ensuring that critical applications get necessary bandwidth.

Additionally, or alternatively, the one or more actions may include customizing mobility management to enhance an experience for the UE 105. By customizing mobility management, the core network 115 may ensure seamless transitions for the UE 105 between different network segments or access points. Additionally, or alternatively, the one or more actions may include utilizing the analytics to dynamically reconfigure network slices to better align with current usage patterns. Dynamic reconfiguration of network slices allows the core network 115 to allocate resources more efficiently, balancing loads according to real-time demands.

Additionally, or alternatively, the one or more actions may include generating a new policy for securing connections in order to adapt to current network conditions. Policy generation based on real-time analytics may ensure that security measures are up-to-date and robust against emerging threats. Additionally, or alternatively, the one or more actions may include the PCF utilizing the analytics to adjust admission control policies, thus maintaining service levels during peak demand times. Admission control adjustments may ensure that network resources are equitably allocated, avoiding overload during high-demand periods.

Additionally, or alternatively, the one or more actions may include selecting an optimal UPF to improve data transmission paths. Selecting a most efficient UPF may enhance data transmission efficiency, reducing latency and improving user experience. Additionally, or alternatively, the one or more actions may include utilizing predictive traffic steering to preemptively redirect flows from overloaded to underloaded segments before congestion manifests.

Additionally, or alternatively, the one or more actions may include modifying the secure connection. Connection modifications based on analytics can enhance security and performance, adapting dynamically to network conditions. Additionally, or alternatively, the received analytics may be utilized to trigger an automated system that reroutes traffic pathways to incorporate newly deployed infrastructure, thus optimizing resource utilization. Automated rerouting helps in efficiently utilizing new network deployments, ensuring optimal resource usage and improved network performance.

In this way, machine learning may be utilized to support ATSSS. For example, an NWDAF may enhance the efficiency of operations of the core network by utilizing a machine learning model to analyze traffic flow data associated with untrusted non-3GPP access networks and to generate analytics. The analytics may provide for dynamic adjustments to traffic routing, policy formulation, and enhancements to stability of secure connections. Through the processing of comprehensive data sets, including subscriber and network function information, the NWDAF may provide analytics that guide ATSSS-related policy decisions, ensuring better alignment with fluctuating network conditions and traffic loads. Thus, the NWDAF may conserve computing resources, networking resources, and/or other resources that would have otherwise been consumed by failing to effectively steer, switch, and split traffic over multiple access types in a 5G core network, failing to incorporate the ePDG and the NSWOF within an analytical scope of the NWDAF, failing to provide procedures and interfaces between the ePDG, the NWDAF, and other network functions to support data-driven and real-time policy decision-making for ATSSS, generating network congestion or bottlenecks that result from less informed traffic steering decisions, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

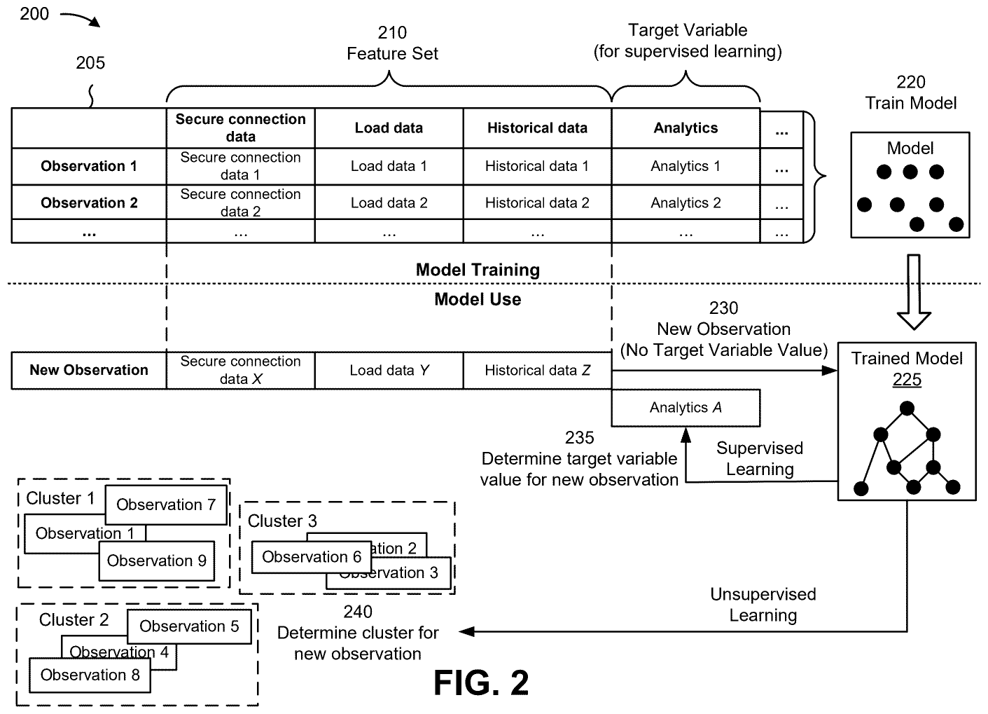

FIG. 2 is a diagram illustrating an example 200 of training and using a machine learning model for generating analytics associated with a secure connection. The machine learning model training and usage described herein may be performed using a machine learning system. The machine learning system may include or may be included in a computing device, a server, a cloud computing environment, and/or the like, such as the NWDAF described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the NWDAF, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the NWDAF. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of secure connection data, a second feature of load data, a third feature of historical data, and so on. As shown, for a first observation, the first feature may have a value of secure connection data 1, the second feature may have a value of load data 1, the third feature may have a value of historical data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “Analytics” and may include a value of analytics 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of secure connection data X, a second feature of load data Y, a third feature of historical data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of analytics A for the target variable of the analytics for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a secure connection data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a load data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate analytics associated with a secure connection. The machine learning system enables recognition and/or identification of tens, hundreds, thousands, or millions of features and/or feature values for tens, hundreds, thousands, or millions of observations, thereby increasing accuracy and consistency and reducing delay associated with generating analytics associated with a secure connection relative to requiring computing resources to be allocated for tens, hundreds, or thousands of operators to manually generate analytics associated with a secure connection.

As indicated above, FIG. 2 is provided as an example. Other examples may differ from what is described in connection with FIG. 2.

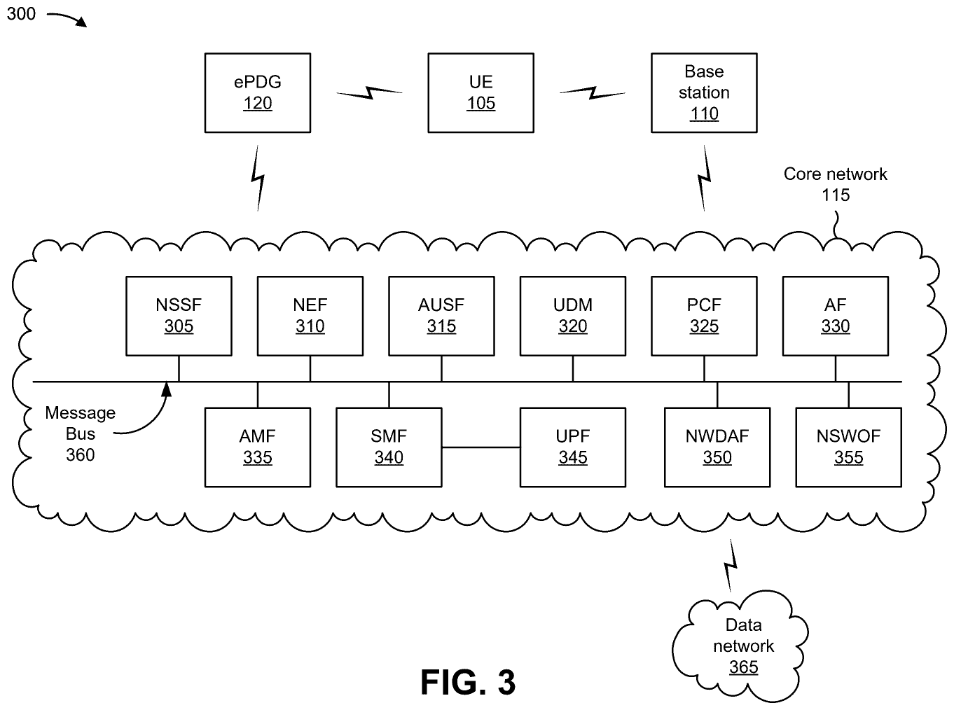

FIG. 3 is a diagram of an example environment 300 in which systems and/or methods described herein may be implemented. As shown in FIG. 3, the example environment 300 may include the UE 105, a base station 110, the core network 115, the ePDG 120, and a data network 365. Devices and/or networks of the example environment 300 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

The ePDG 120 includes one or more devices capable of receiving, generating, storing, processing, and/or providing information, such as information described herein. For example, the ePDG 120 facilitates secure communication between the UE 105 and the core network 115 over untrusted non-3GPP access networks, such as Wi-Fi. The ePDG 120 may utilize a secure connection (e.g., an Internet protocol security (IPSec) tunnel) to provide secure communication between the UE 105 and the core network 115 over an untrusted non-3GPP access network. The ePDG 120 may handles mobility management for a UE 105 moving between different networks, ensuring session continuity and seamless handovers between Wi-Fi and cellular networks. The ePDG 120 acts as an intermediary between the non-3GPP access network and the core network 115, such the UPF. By creating secure IPsec tunnels, the ePDG prevents unauthorized access and protects user data from potential threats present in untrusted networks.

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 3 may be an example of a service-based architecture, in some implementations, the core network 115 may be implemented as a reference-point architecture and/or a 4G core network, among other examples.

As shown in FIG. 3, the core network 115 may include a number of functional elements. The functional elements may include, for example, a network slice selection function (NSSF) 305, a network exposure function (NEF) 310, an authentication server function (AUSF) 315, a unified data management (UDM) component 320, a policy control function (PCF) 325, an application function (AF) 330, an access and mobility management function (AMF) 335, a session management function (SMF) 340, a user plane function (UPF) 345, an NWDAF 350, and/or an NSWOF 355. These functional elements may be communicatively connected via a message bus 360. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 305 includes one or more devices that select network slice instances for the UE 105. By providing network slicing, the NSSF 305 allows an operator to deploy multiple substantially independent end-to-end networks potentially with the same infrastructure. In some implementations, each slice may be customized for different services.

The NEF 310 includes one or more devices that support exposure of capabilities and/or events in the wireless telecommunications system to help other entities in the wireless telecommunications system discover network services.

The AUSF 315 includes one or more devices that act as an authentication server and support the process of authenticating the UE 105 in the wireless telecommunications system.

The UDM 320 includes one or more devices that store user data and profiles in the wireless telecommunications system. The UDM 320 may be used for fixed access and/or mobile access in the core network 115.

The PCF 325 includes one or more devices that provide a policy framework that incorporates network slicing, roaming, packet processing, and/or mobility management, among other examples.

The AF 330 includes one or more devices that support application influence on traffic routing, access to the NEF 310, and/or policy control, among other examples.

The AMF 335 includes one or more devices that act as a termination point for non-access stratum (NAS) signaling and/or mobility management, among other examples.

The SMF 340 includes one or more devices that support the establishment, modification, and release of communication sessions in the wireless telecommunications system. For example, the SMF 340 may configure traffic steering policies at the UPF 345 and/or may enforce user equipment Internet protocol (IP) address allocation and policies, among other examples.

The UPF 345 includes one or more devices that serve as an anchor point for intraRAT and/or interRAT mobility. The UPF 345 may apply rules to packets, such as rules pertaining to packet routing, traffic reporting, and/or handling user plane quality of service (QoS), among other examples.

The NWDAF 350 includes one or more devices that enable advanced data analytics within the core network 115. The NWDAF 350 collects, processes, and analyzes data from various network elements to provide valuable insights that can help improve the efficiency, performance, and management of the core network 115. The NWDAF 350 may gather data from multiple sources within the core network 115, such as the AMF 335, the SMF 340, the UPF 345, and/or the like. The NWDAF 350 may utilize and other analytical tools with the collected data to identify trends, detect anomalies, and predict future network conditions. The NWDAF 350 may provide reports and analytics outputs to various network entities, such as the PCF 325, the AF 330, an operations and management (OAM) system, and/or the like.

The NSWOF 355 includes one or more devices that enable the UE 105 to shift a portion of data traffic from a cellular network to a Wi-Fi network without requiring a seamless handover. The NSWOF 355 does not prioritize maintaining uninterrupted service during the transition between the networks, which means that users may experience brief interruptions or service disruptions. The NSWOF 355 may manage and oversee the offloading process for the UE 105 by communicating with both the UE 105 and network elements. The NSWOF 355 may evaluate detected Wi-Fi networks based on predefined criteria, such as signal strength, throughput capability, and security requirements. When a suitable Wi-Fi network is identified, the NSWOF 355 may initiate offloading. By offloading certain types of data traffic to Wi-Fi networks, the NSWOF 355 helps reduce loads on cellular networks, thus enhancing overall efficiency and user experience.

The message bus 360 represents a communication structure for communication among the functional elements. In other words, the message bus 360 may permit communication between two or more functional elements.

The data network 365 includes one or more wired and/or wireless data networks. For example, the data network 365 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the example environment 300 may perform one or more functions described as being performed by another set of devices of the example environment 300.

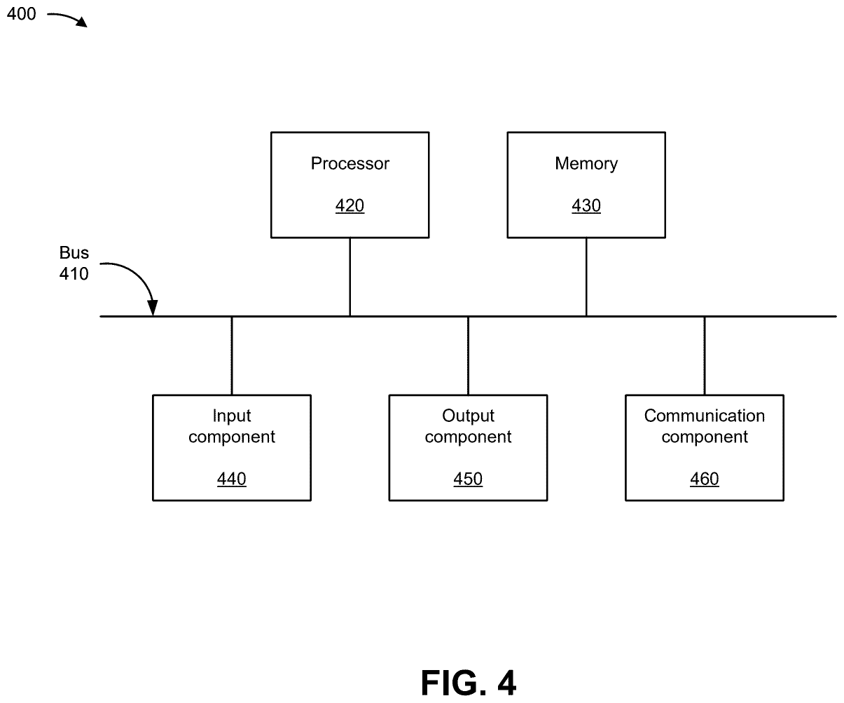

FIG. 4 is a diagram of example components of a device 400, which may correspond to the UE 105, the base station 110, the ePDG 120, the NSSF 305, the NEF 310, the AUSF 315, the UDM 320, the PCF 325, the AF 330, the AMF 335, the SMF 340, the UPF 345, the NWDAF 350, and/or the NSWOF 355. In some implementations, the UE 105, the base station 110, the ePDG 120, the NSSF 305, the NEF 310, the AUSF 315, the UDM 320, the PCF 325, the AF 330, the AMF 335, the SMF 340, the UPF 345, the NWDAF 350, and/or the NSWOF 355 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

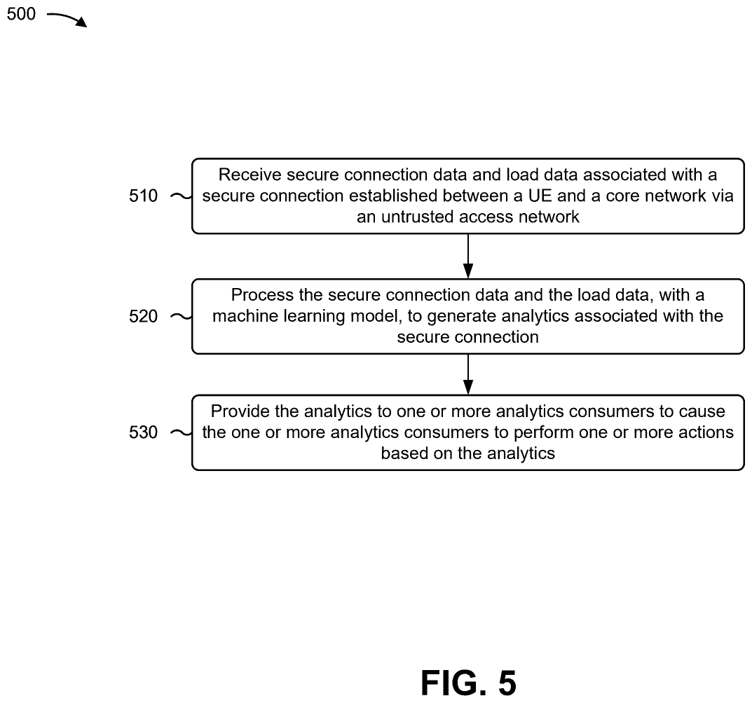

FIG. 5 is a flowchart of an example process 500 for utilizing machine learning to support ATSSS. In some implementations, one or more process blocks of FIG. 5 may be performed by a device (e.g., a network device of the core network, such as the NWDAF 350). In some implementations, one or more process blocks of FIG. 5 may be performed by another device or a group of devices separate from or including the device, such as another network device (e.g., the ePDG 120, the NSWOF 355, and/or the like) of the core network 115. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving secure connection data and load data associated with a secure connection established between a UE and a core network via an untrusted access network (block 510). For example, the device may receive secure connection data and load data associated with a secure connection established between a UE and a core network via an untrusted access network, as described above. In some implementations, the secure connection data and the load data includes one or more of data associated with the UE, network function data associated with the core network, events exposure data associated with the secure connection, operations and management data associated with the core network, driving test data associated with the core network, quality of service flow data associated with the secure connection, traffic usage data associated with the secure connection, or historical data associated with the core network. In some implementations, the secure connection is an IPSec tunnel provided between the UE and the core network. In some implementations, the untrusted access network is a Wi-Fi network.

In some implementations, receiving the secure connection data and the load data includes receiving the secure connection data and the load data from an ePDG that established the secure connection between the UE and the core network. In some implementations, receiving the secure connection data and the load data includes establishing a connection with an ePDG, and receiving the secure connection data and the load data from the ePDG via the connection.

As further shown in FIG. 5, process 500 may include processing the secure connection data and the load data, with a machine learning model, to generate analytics associated with the secure connection (block 520). For example, the device may process the secure connection data and the load data, with a machine learning model, to generate analytics associated with the secure connection, as described above. In some implementations, processing the secure connection data and the load data, with the machine learning model, to generate the analytics associated with the secure connection includes classifying types of traffic associated with the secure connection data and the load data, and determining load conditions for the types of traffic.

As further shown in FIG. 5, process 500 may include providing the analytics to one or more analytics consumers to cause the one or more analytics consumers to perform one or more actions based on the analytics (block 530). For example, the device may provide the analytics to one or more analytics consumers to cause the one or more analytics consumers to perform one or more actions based on the analytics, as described above. In some implementations, the one or more actions include one or more of providing ATSSS for the secure connection, providing mobility management for the UE, generating a policy for the secure connection, selecting a UPF of the core network to communicate with the secure connection, or modifying the secure connection.

In some implementations, the one or more analytics consumers include one or more of an NEF of the core network, a PCF of the core network, an AF of the core network, or an OAM system associated with the core network. In some implementations, the one or more actions include determining one or more access networks for switching or splitting traffic of the UE.

In some implementations, process 500 includes causing an update to be provided to the UE, wherein the update causes the UE to switch or split the traffic based on the one or more access networks. In some implementations, process 500 includes training the machine learning model based on the secure connection data, the load data, and the analytics. In some implementations, process 500 includes providing, to a network device that established the secure connection between the UE and the core network, updated traffic management settings based on the analytics.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, secure connection data and load data associated with a secure connection established between a user equipment (UE) and a core network via an untrusted access network;
processing, by the device, the secure connection data and the load data, with a machine learning model, to generate analytics associated with the secure connection; and
providing, by the device, the analytics to one or more analytics consumers to cause the one or more analytics consumers to perform one or more actions based on the analytics.

2. The method of claim 1, wherein the secure connection data and the load data includes one or more of:
subscriber data associated with the UE,
network function data associated with the core network,
events exposure data associated with the secure connection,
operations and management data associated with the core network,
drive test data associated with the core network,
quality of service flow data associated with the secure connection,
traffic usage data associated with the secure connection, or
historical data associated with the core network.

3. The method of claim 1, wherein the secure connection is an Internet protocol security tunnel provided between the UE and the core network.

4. The method of claim 1, wherein the untrusted access network is a Wi-Fi network.

5. The method of claim 1, wherein receiving the secure connection data and the load data comprises:
receiving the secure connection data and the load data from an evolved packet data gateway that established the secure connection between the UE and the core network.

6. The method of claim 1, wherein the one or more actions include one or more of:
providing access traffic steering, switching, and splitting for the secure connection, providing mobility management for the UE,
generating a policy for the secure connection,
selecting a user plane function of the core network to communicate with the secure connection, or
modifying the secure connection.

7. The method of claim 1, wherein processing the secure connection data and the load data, with the machine learning model, to generate the analytics comprises:
classifying, with the machine learning model, types of traffic associated with the secure connection data and the load data; and
determining, with the machine learning model, load conditions for the types of traffic.

8. A device, comprising:
one or more processors configured to:
receive secure connection data and load data associated with a secure connection established between a user equipment (UE) and a core network via an untrusted access network,
wherein the secure connection is an Internet protocol security tunnel provided between the UE and the core network;
process the secure connection data and the load data to generate analytics associated with the secure connection; and
provide the analytics to one or more analytics consumers to cause the one or more analytics consumers to perform one or more actions based on the analytics.

9. The device of claim 8, wherein the one or more processors, to receive the secure connection data and the load data, are configured to:
establish a connection with an evolved packet data gateway; and
receive the secure connection data and the load data from the evolved packet data gateway via the connection.

10. The device of claim 8, wherein the one or more analytics consumers include one or more of a network exposure function of the core network, a policy control function of the core network, an application function of the core network, or an operations and management system associated with the core network.

11. The device of claim 8, wherein the one or more actions include determining one or more access networks for switching or splitting traffic of the UE.

12. The device of claim 11, wherein the one or more processors are further configured to:
cause an update to be provided to the UE,
wherein the update causes the UE to switch or split the traffic based on the one or more access networks.

13. The device of claim 8, wherein the one or more processors are further configured to:
train a machine learning model with historical secure connection data, historical load data, and historical analytics,
wherein the machine learning model is utilized to generate the analytics associated with the secure connection.

14. The device of claim 8, wherein the one or more processors are further configured to:
provide, to a network device that established the secure connection between the UE and the core network, updated traffic management settings based on the analytics.

15. A non-transitory computer-readable medium storing a set of instructions, the set of instructions comprising:
one or more instructions that, when executed by one or more processors of a device, cause the device to:
receive secure connection data and load data associated with a secure connection
established between a user equipment (UE) and a core network via an untrusted access network;
process the secure connection data and the load data, with a machine learning model, to generate analytics associated with the secure connection; and
provide the analytics to one or more analytics consumers to cause the one or more analytics consumers to perform one or more actions based on the analytics,
wherein the one or more analytics consumers include one or more of a network exposure function of the core network, a policy control function of the core network, an application function of the core network, or an operations and management system associated with the core network.

16. The non-transitory computer-readable medium of claim 15, wherein the one or more instructions, that cause the device to receive the secure connection data and the load data, cause the device to:
receive the secure connection data and the load data from an evolved packet data gateway that established the secure connection between the UE and the core network.

17. The non-transitory computer-readable medium of claim 15, wherein the one or more instructions, that cause the device to process the secure connection data and the load data, with the machine learning model, to generate the analytics, cause the device to:
classify, with the machine learning model, types of traffic associated with the secure connection data and the load data; and
determine, with the machine learning model, load conditions for the types of traffic.

18. The non-transitory computer-readable medium of claim 15, wherein the one or more instructions, that cause the device to receive the secure connection data and the load data, cause the device to:
establish a connection with an evolved packet data gateway; and
receive the secure connection data and the load data from the evolved packet data gateway via the connection.

19. The non-transitory computer-readable medium of claim 15, wherein the one or more instructions further cause the device to:
train the machine learning model based on the secure connection data, the load data, and the analytics.

20. The non-transitory computer-readable medium of claim 15, wherein the one or more instructions further cause the device to:
provide, to a network device that established the secure connection between the UE and the core network, updated traffic management settings based on the analytics.
